(19) United States
(12) Patent Application Publication
(10) Pub. No.: US 2026/0320196 A1
(43) Pub. Date: Oct. 15, 2026

(54) SECURITY ANALYSIS OF HEAP MEMORY

(71) Applicant: ORACLE INTERNATIONAL CORPORATION, Redwood Shores, CA (US)

(72) Inventors: Dharmalingam GANESAN, Crofton, MD (US); David CLIFTON, Ellicott City, MD (US)

(21) Appl. No.: 19/179,605

(22) Filed: Apr. 15, 2025

(51) Int. Cl. G06F 21/57

(52) U.S. Cl. CPC G06F 21/577; G06F 2221/034

(57) ABSTRACT

Systems, methods, and other embodiments associated with detecting security vulnerabilities in heap memory usage are described. In one embodiment, a runtime data model is based on a petri net configured to track heap memory usage in a target system. The runtime data model tracks heap memory allocation and deallocation function calls. The runtime data model is simulated in the petri net with runtime data the target system, wherein the runtime data model associates the heap memory allocation functions with corresponding heap memory deallocation functions in a visual graphical format. Security vulnerabilities are detected by the model, for example, where a specific heap memory allocation function does not have a corresponding heap memory deallocation function. An alert may be generated that identifies the security vulnerabilities including the associated specific heap memory allocation function that does not have the corresponding heap memory deallocation function.

### BACKGROUND

Heap memory is a type of memory allocation used in programming, particularly for dynamic memory management. In general, heap memory is a dynamically allocated region of a computer's memory that is managed by a program/application during runtime. Heap memory is used for objects and data structures that need to persist beyond the execution of a function or block of code in the program. Unlike stack memory, which is used for static memory allocation and has a strict last-in, first-out (LIFO) structure, heap memory allows for more flexible storage.

When an application/program allocates memory on the heap, it can request a specific amount of memory at runtime, and this memory remains available until the application explicitly frees it. This is useful for data structures whose size may change during the program's execution, like linked lists or dynamic arrays. Overall, heap memory is essential for creating complex data structures and managing resources efficiently in many applications.

However, managing heap memory comes with overhead, including the need to manually allocate and deallocate memory in the code itself. Incorrect memory usage by the code can lead to security issues like memory leaks, dangling pointers, and other memory issues.

Problems arise due to misuse of heap memory APls such as malloc and free, which can lead to security vulnerabilities. An application may contain errors in the code that a) frees up (deallocates) already freed memory (a.k.a., double free), b) fails to free up allocated memory, or c) reads/writes to freed memory, etc. These are caused by programming mistakes and lead to security vulnerabilities that can be exploited by hackers, cybercriminals, malware, and/or other programs designed to take advantage of computer system flaws.

In practice, several zero-day vulnerabilities are often reported due to the incorrect use of these memory APls in systems such as web-browsers, operating systems, and so forth. A zero-day vulnerability is a security flaw in software or hardware that is unknown to the vendor or developer. This means that there have been “zero days” since it was discovered, and there is no patch or fix available to protect against it.

There is a need for improved techniques that detect and prevent security vulnerabilities due to misuse of heap memory APls, including but not limited to, malloc and free.

### SUMMARY

In one embodiment, a computing system is described, which is implemented with a memory security analysis technique that detects potential security vulnerabilities based on misuse of heap memory by a system under test (target system). In one embodiment, the memory security analysis technique may comprise actions: define a runtime data model based on a petri net configured to track heap memory usage in a target system, wherein the runtime data model tracks heap memory allocation functions and heap memory deallocation functions; execute the target system and collect runtime data including the heap memory usage; simulate the runtime data model in the petri net with the runtime data, wherein the runtime data model associates the heap memory allocation functions with corresponding heap memory deallocation functions in a visual graphical format; detecting security vulnerabilities where a specific heap memory allocation function does not have a corresponding heap memory deallocation function; and generating an alert that identifies the security vulnerabilities including the associated specific heap memory allocation function that does not have the corresponding heap memory deallocation function.

In another embodiment, a computing system is described comprising: one or more computing devices operably connected to communicate over one or more communication networks via one or more network interfaces; at least one processor connected to at least one memory, wherein the at least one processor is operably connected to at least one of the one or more computing devices; and a non-transitory computer readable medium including instructions stored thereon that when executed by at least the processor cause the computing system to:

Access and retrieve runtime data collected from a target software system; populate a runtime data model, implemented as a colored petri net model, with data from the runtime data, wherein the colored petri net model is configured to identify and track heap memory usage in the target system and detect memory security violations, wherein the colored petri net model tracks at least heap memory allocation functions and heap memory deallocation functions based on the runtime data; simulate the colored petri net model with the runtime data to detect memory security violations; wherein the colored petri net model is configured to populate a memory allocation place with an allocation token for each heap memory allocation function that occurs in the runtime data; wherein the colored petri net model is configured to populate a memory deallocation place with a deallocation token for each heap memory deallocation function that occurs in the runtime data; wherein the colored petri net model is further configured to associate the allocation tokens with corresponding deallocation tokens in a visual graphical format; detecting security vulnerabilities where an allocation token for a specific heap memory allocation function does not have a corresponding deallocation token for a corresponding heap memory deallocation function; and generating an end state of the colored petri net model in the visual graphical format, wherein upon completion of the simulation, the end state identifies the security vulnerabilities including the associated specific heap memory allocation function based on locations of the allocation tokens and locations of the deallocation tokens in the colored petri net model.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a system associated with a security analysis of heap memory usage in a target system.

FIGS. 2A and 2B illustrates one embodiment of a colored petri net model implemented to detect violations in memory allocations and deallocations in a target system.

FIGS. 3A and 3B illustrates another embodiment of the model from FIG. 2A including a memory use checker.

FIG. 4 illustrates one embodiment of a method associated with detecting violations in memory allocations and deallocations in a target system.

FIG. 5 illustrates one embodiment of a method that continues from FIG. 4 associated with detecting violations in memory usage in a target system.

FIG. 6 illustrates an embodiment of a computing system configured with the example systems and/or methods disclosed.

### DETAILED DESCRIPTION

Systems and methods are described herein that implement techniques for security analysis and detection of heap memory usage. In one embodiment, a security system is implemented for the detection and prevention of security vulnerabilities due to misuse of heap memory APls, including but not limited to, memory allocation (malloc API) and memory deallocation (free API). The present security system detects and prevents these types of security vulnerabilities, also referred to as memory safety/security violations.

The present system is a new technique that can be used to verify whether a running system is properly using heap memory of a computing system, and in particular, whether the running system is properly using heap memory APls, such as malloc and free. In one embodiment, the present technique identifies and flags any incorrect use of these heap memory APls.

In practice, several zero-day vulnerabilities are often reported due to the incorrect use of heap memory APls in systems such as web-browsers, operating systems, and so forth. A zero-day vulnerability is a security flaw in software or hardware that is unknown to the vendor or developer. This means that there have been “zero days” since it was discovered, and there is no patch or fix available to protect against it. One problem that is solved by the present security system is the detection of incorrect usage of heap memory and prevention of security vulnerabilities due to misuse of heap memory APls.

In prior techniques, it was not reasonable or practical for raw data (a.k.a., events) to be reviewed by security analysts for any misuse of heap memory APls due to the sheer volume of the data (e.g., hundreds of thousands of lines of code). Further, analysts had to correlate different events because these APls have data parameters; one has to match not just corresponding events but also match corresponding data. These problems are resolved by the present system, in one embodiment, by implementing colored petri nets that automatically detect misuse of heap memory APls. A colored petri net is also referred to herein as CP-net or CP-net model, which are used interchangeably.

### System Overview

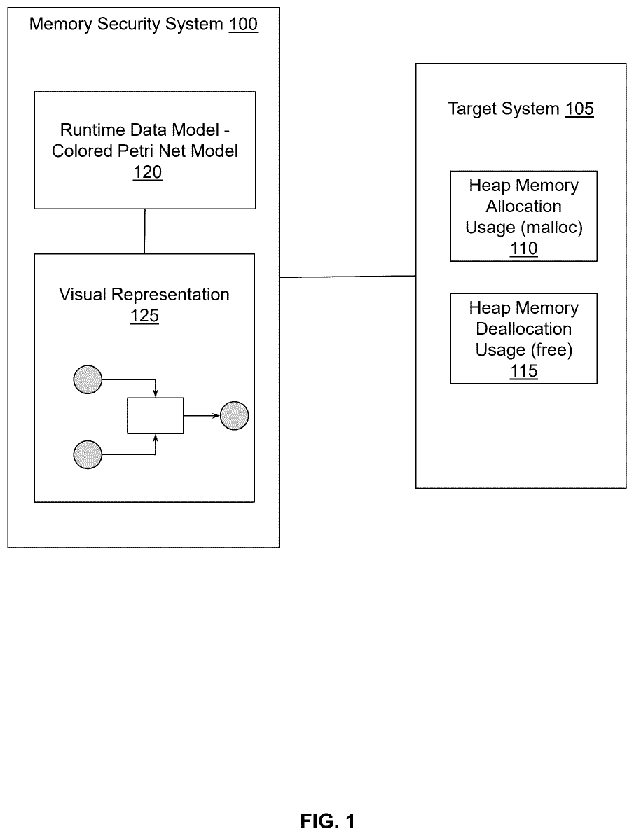

With reference to FIG. 1, one embodiment of a memory security system 100 is illustrated that is associated with detecting and preventing incorrect usage of heap memory in a target system 105 (e.g., system under test).

As previously stated, problems may arise due to misuse of heap memory APls, including but not limited to the malloc API and free API, which can lead to security vulnerabilities. An application in the target system 105 may contain errors caused by code that a) frees up (deallocates) already freed memory (a.k.a., double free), b) fails to free up allocated memory, or c) reads/writes to freed memory, etc. These are caused by programming mistakes and lead to security vulnerabilities that can be exploited by hackers, cybercriminals, malware, and/or other programs designed to take advantage of computer system flaws.

In general, the malloc API is a library function in C and C++ used for dynamic memory allocation. Malloc stands for “memory allocation.” When a running application/program calls the malloc function, the computing system/operating system allocates a specified number of bytes in heap memory and returns a pointer to the beginning of the allocated memory block. Typical syntax may be: malloc(size_t size).

Where “size_t” is an unsigned integer type that represents the size of the memory block you want allocated in bytes. “Size” is the requested number of bytes to allocate.

The malloc function returns a pointer to the starting address of the allocated memory if the allocation is successful; otherwise, it returns NULL if the allocation fails (e.g., if there is insufficient memory). Memory allocated with malloc must be deallocated using the free( ) API to prevent memory leaks or other potential security vulnerabilities. Another type of memory usage violation that may be implemented in the present system is a check for a malloc call that returns a NULL pointer, which may cause problems downstream in the code.

Various examples of memory allocation functions include the memory allocation function malloc( ), a contiguous allocation function calloc( ) that allocates a block of memory for multiple elements and initializes all bytes to zero, and a reallocate function realloc( ) that is used to resize previously allocated memory. In another embodiment, the present system may be implemented to detect memory usage violations from any of these types of memory usage functions.

Free( ) is a function in C that gives memory back to the system after the running application is done using it. When an application allocates a memory block, the requested memory is allocated for use, but that memory block should be returned to the system (deallocated) when the application is finished using it. Otherwise, the program will hog memory unnecessarily (e.g., a memory leak). Free(ptr) is a function to deallocate a previously allocated block of memory by identifying the pointer “ptr” which represents the memory address of the allocated memory.

Common problems may occur in an application such as a failing to free a memory block that has been allocated. This occurs when the code calls a malloc function but there is no corresponding free function for the same memory. Double Free is where the code calls the free( ) function twice on the same pointer. This corrupts the heap memory. Using the memory after free: dereferencing a pointer after free( ) leads to undefined behavior.

In one embodiment, the present system is based on dynamic analysis and a formal model of heap memory usage using a Colored Petri net modeling language to define a colored petri net model (CP-net model). The CP-net model is configured to check whether a running target system under test 105 is using the malloc and free APls correctly. The target system under test or analysis may be instrumented to collect runtime data about heap memory allocation functions 110 and heap memory deallocation functions 115, which include malloc APIs and free APls. The collected runtime data is used as input to the memory security system 100 to detect whether the target system 105 performs any improper memory usage.

In one embodiment, the memory security system 100 is implemented with a runtime data model 120 that may be configured to simulate and monitor whether a running target system is using memory allocation functions (e.g., malloc APIs) and memory deallocation functions (e.g., free APls) correctly according to a set of usage rules. The usage rules may define proper instances of memory usage and/or invalid instances of memory usage, which are further explained below.

In one embodiment, the runtime data model 120 is defined based on a petri net and may be configured as a Colored Petri net model 120 (CP-net model). Rules regarding the use of the memory allocation APls and the memory deallocation APIs are formally specified using in the Colored Petri net model 120 to identify instances of memory usage, track the usage during runtime, and detect whether the usage is proper or improper based on the defined rules of the model. In one embodiment, the model 120 provides a visual representation 125 of memory usage and a final state of the usage that is simple to investigate and identify where any usage violations occurred in the target system 105. Yet, the model 120 is a formally defined system to provide accurate automated analysis of even very large, complex software systems with complex memory usage functions and dependencies, which typical debugging cannot accurately track. In one manner, a colored petri net model has similarities to a finite state machine.

As such, the model 120 is configured to simulate execution of the target system 105 from a set of runtime data collected from the target system 105. During simulation, the model 120 detects where instances of invalid memory usage occur in the target system 105 and thus may prevent potential security vulnerabilities. The runtime data model 120 may be configured to visually track heap memory usage in the target system 105 by visually displaying, in a graphical user interface, the heap memory allocation functions and heap memory deallocation functions that occur in the executing code of the target system 105.

The target system 105 may be executed and raw data from runtime is collected from the target system 105. In another embodiment, runtime data may be previously collected and used by the runtime data model 100. The runtime data may be accessed and retrieved from a database that stores the runtime data. The runtime data is input into the model 120, which checks whether the running system is properly using the malloc and free APls, for example.

The colored petri net model 120 may be configured to track and analyze whether the running target system is (a) freeing up already freed memory, which is an error, (b) not freeing up allocated memory, which is an error, c) reading/writing to freed memory, which is a usage error, and/or other memory usage rules that define memory usage errors that are being detected and analyzed.

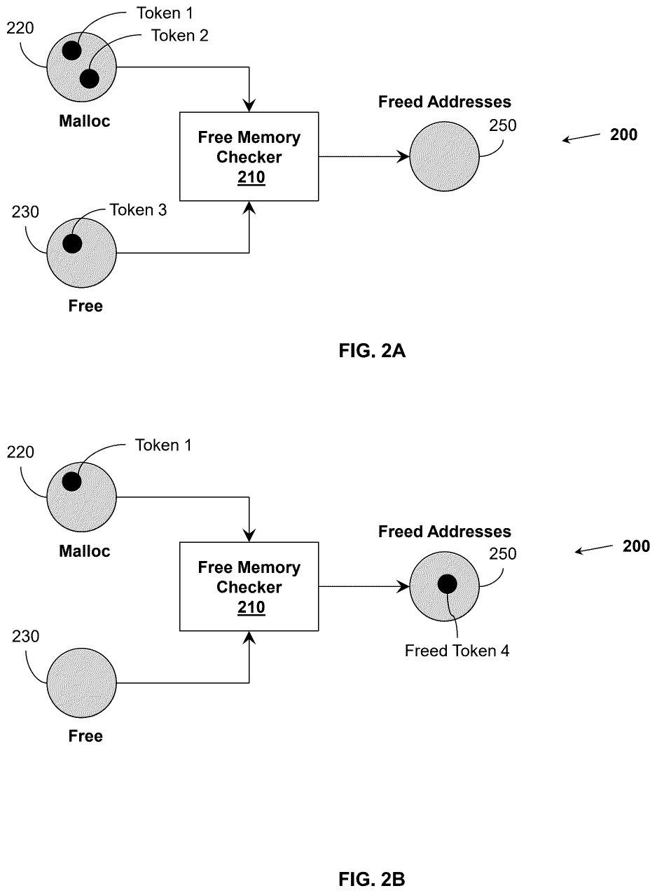

In one embodiment, the runtime data model 120 (e.g., colored petri net) is simulated with the runtime data. During simulation, the runtime data model 120 detects and populates components of the model with heap memory allocation functions (malloc) and deallocation functions (free) along with their runtime attributes. The model 120, as defined by usage rules, then tracks and associates the heap memory allocation functions with corresponding heap memory deallocation functions to determine proper and improper usage. A state of the model at any time may be displayed in a visual graphical format for simple investigation by a reviewer. This is further explained with reference to FIG. 2.

The runtime data model 120 is configured to detect security vulnerabilities, which are defined by one or more memory usage rules for proper usage and/or improper usage. For example, an improper usage rule may be configured to detect when a specific heap memory allocation function (that allocates a memory block) does not have a corresponding heap memory deallocation function (that frees the same memory block).

For example, an improper usage occurs when memory address 1234 is allocated with malloc but the model 120 does not encounter a corresponding free function that deallocates memory address 1234 subsequently in time after the allocation. Thus, memory address 1234 is not properly deallocated, which constitutes a misuse of heap memory and is a potential security vulnerability. Other misuses may also be detected, which are described below.

Upon completion of the simulation, the runtime data model 120 may generate and transmit an alert that identifies any detected instances of security vulnerabilities to enable early prevention of the vulnerabilities in a target system 105, thus preventing a security violation. In one embodiment, the alert may include data including the associated specific heap memory allocation function (malloc) that does not have a corresponding free function, locations of double free calls, and/or other detected misusage instances. In one embodiment, the alert may include a displayed message on a display screen, a message transmitted to a remote computing device, and/or combinations thereof.

In one embodiment, the detection and/or the alert may trigger corrective actions to modify the code of the target system 105 to correct and/or resolve the detected instances of memory misusage. Recommendations may be generated, for example, for deallocating memory by inserting a free( ) call in the code for a corresponding malloc( ) call where allocated memory that was not properly deallocated; a double free violation may be resolved by deleting the second free( ) call from the code; or other recommended corrective action based on the type of memory misusage. In another embodiment, the code may be automatically modified and corrected based on the detected misusage.

The visual representation 125 of the security model 120 may also be displayed that shows a visual end state of the model. The visual end state (e.g., state of the CP-net model) may be used to visually identify whether any memory misusage has occurred. As will be described in FIG. 2, in one embodiment, the colored petri net model 120 displays tokens in the visual end state and the locations of the tokens may be used to identify that memory misusage has occurred. Thus, the end state identifies security vulnerabilities based on final locations of allocation tokens and final locations of the deallocation tokens in the colored petri net model.

The present security detection technique is an advantage and improvement to prior techniques. For example, the CP-net model (runtime data model) can be easily displayed into graphical form, visualized, and analyzed to visually identify memory misusage in a target system. Further, the colored petri net (CP-net) model allows for a simple mechanism for expanding the model with new or modified memory usage rules for testing other forms of valid and/or invalid memory usage. Modifications to the model may be easily added due to the modular structure of Petri nets, which eliminates numerous and complex debugging code that must be inserted into applications that some previous debugging techniques are based on.

Another advantage of the present technique is that it can handle data parameters using the tokens of the colored petri nets. Each token may correspond to a specific instance of a memory usage function in the target system and the token is configured to contain attributes associated with the memory usage function (e.g., source and location of memory function, memory address, time of function, etc.). Many of the prior existing techniques are formal logic-based techniques and as such are not well equipped to handle data parameters which makes them difficult to define, modify, use and implement.

### Colored Petri Net (CP-Net) Embodiment

With reference to FIG. 2A, one embodiment of the runtime data model 120 is shown and implemented as a colored petri net model 200 (also referred to herein as a CP-net or CP-net model, interchangeably). CP-net Model 200 is configured to track memory allocation functions (malloc), memory deallocation functions (free), and identify correctly deallocated memory addresses (freed addresses) in a target system. The model 200 may be easily modified and expanded to detect other types of heap memory usage and/or misusage actions as will be described below.

In general, petri nets are a mathematical modeling tool used to describe and analyze the flow of information and control in systems. They include graphical components called places, transitions, and tokens. “Places” (usually drawn as circles) represent conditions or states in the system. “Transitions” (usually drawn as rectangles) represent events or actions that can change the state. In colored petri nets, “Tokens” (drawn as small dots inside Places) are assigned and carry data of a specific action, as described below. The locations of tokens (located in places) may be used to indicate a current state of the system being modeled. Places and transitions may be assigned to different colors in the CP-net model, where a color represents a data type or data structure. For example, different “places” that have the same color in the CP-net model 200, represent the same data type. In other words, places with the same color will hold tokens of the same data type.

The behavior of the CP-net model 200 is defined by the movement of tokens between places as transitions are “fired,” which can model various systems, including computer networks, manufacturing processes, and workflows. When a transition “fires,” it consumes tokens from its input places and produces tokens in its output places, based on predefined rules. ln the CP-net model 200, tokens are data holders according to data type definitions. Every place in the CP-net is assigned a data type, and every token inside a place is an instance of the corresponding type. Places with the same data type are assigned the same color. Every transition of the CP-net is defined by and contains a precondition (e.g., a conditional expression) based on input places. When the precondition is true, then the transition will fire, and tokens from the input places that satisfy the precondition will be consumed (e.g., removed and/or moved to an output place).

In FIG. 2A, the colored petri net model 200 defines a visual model in a visual graphical format including a free memory checker 210 as a transition and includes a first input place 220 (malloc place 220) that provides input data to the free memory checker 210. The malloc place 220 is configured to track the heap memory allocation functions of malloc that occur during runtime in the target system with a first set of tokens. In other words, the malloc place 220 is defined in a first graphical component of the visual graphical format.

During simulation, the malloc place 220 is populated with allocation tokens for each malloc function that occurs in the runtime data. Each token corresponds to a specific instance of a memory allocation call (a malloc call) and contains attributes including at least an allocated memory address and time of allocation. Other attributes may also be stored with the token as described below. Thus, each time malloc is called in the target system, a token is created in the malloc place 220.

A second input place 230 (free place 230) provides input to the free memory checker 210 and tracks the heap memory deallocation functions of free( ) that occur during runtime in the target system with a second set of tokens. Thus, the free place 230 is defined as a second graphical component of the visual graphical format.

During simulation, the free place 230 is populated with deallocation tokens (free tokens) for each free( ) function that occurs in the runtime data. Each token in the free place 230 corresponds to a specific instance of a memory deallocation call (a free( ) call) and contains attributes including at least a freed memory address that was deallocated and time of deallocation. Other attributes may also be stored with the token as described below. Thus, each time free( ) is called in the target system, a token is created in the free place 220.

A freed addresses place 250 is an output place from the transition called free memory checker 210. The runtime data model (CP-net model 200) is configured such that with the transition 210 it removes an allocation token from the malloc place 220 and removes a corresponding deallocation token (free token) from the free place 230 when a particular memory address is correctly allocated and deallocated as represented by the tokens.

Freed address place is configured to receive output tokens from the transition free memory checker 210 when a precondition of the transition “fires.” The freed addresses place 250 is configured to track tokens for freed memory addresses that are correctly allocated and deallocated in the runtime data based on a precondition rule defined by the free memory checker 210.

As previously stated, dynamic memory needs to be used safely in a computing system. Otherwise, the underlying heap memory structures may be corrupted and exploitable. There are numerous memory safety properties that may be implemented to reduce the attack surface due to dynamic memory use. In one embodiment, one or more of the following memory safety properties may be defined by the CP-net model 200 to track and detect memory misusage.

Property 1: Free after malloc

To prevent memory exhaustion or denial of service, memory allocated using malloc( ) should be subsequently freed using the deallocation function free( ). This property is important in target systems especially for long-running programs to prevent huge memory use. A program that uses the malloc( ) function should have subsequent code that releases the allocated memory using the free( ) function otherwise a misuse error occurs.

Property 2: Free is called once “Double free” is a security flaw that occurs when the free( ) function is called more than once for the same memory location that was already freed. lf a program calls free( ) twice with the same argument, the heap memory data structures become corrupted. An attacker may be able to control the heap data structure to execute arbitrary code.
Property 3: There is no use after free “Use after free” is a security flaw that occurs if a program reads from (or writes to) an already freed memory address. The use of previously freed memory may corrupt valid data. Further, it may be possible for attackers to exploit this flaw to execute arbitrary code.

These properties may be defined as preconditions in the transition represented by the free memory checker 210 in FIG. 2A.

An example state of model 200 in FIG. 2A, it shows two (2) tokens in malloc place 220. Let token 1 represent a first malloc call that allocates memory address at time N. Let token 2 represent a second malloc call that allocates memory address [456] at time M. Let token 3 represent a free call that deallocates memory address [456] at time M+X.

For example, one precondition rule defined by the free memory checker 210 is associated with Property 1: Free after malloc. This rule may state that when an allocated memory address of an allocation token (first token) from the malloc place 220 corresponds to a freed memory address of a deallocation token (second token) in the free place 230 that occurs at a subsequent time, then the transition fires. The precondition rule may state that the transition fires for two tokens when: a Malloc address =a Free address and the Malloc time is before the Free time. This condition represents a valid memory usage where memory was allocated and then properly deallocated.

When the free memory checker transition fires (condition is satisfied), the model is configured to perform at least these token actions:
(i) the allocation token (first token) is removed from the malloc place 220;
(ii) the deallocation token (second token) is removed from the free place 230; and
(iii) the freed address place 250 is populated with a freed token that contains the freed memory address and the time of free/deallocation. This may be performed by moving the deallocation token to the freed address place 250.

For example, FIG. 2B shows a state change of the model 200 from FIG. 2A. In FIG. 2B, the transition rule fires since malloc Token 2 [addr 456, time M] matches free Token 3 [addr 456, time M+X] and the malloc Token 2 time is before (less than) free Token 3 time. This means that memory address [456] was allocated and then subsequently freed (deallocated). This is a correct usage of malloc and free for address [456]. Thus, malloc Token 2 is removed from malloc place 220, corresponding free Token 3 is removed from free place 230, and a freed Token 4 is added/moved to the freed addresses place 250. Freed Token 4 is stored with attributes representing freed address [456] and freed time M+X. Since Token 4 has similar or the same attributes as free Token 3, the free memory checker 210 may simply move Token 3 from the free place 230 and place the token into the freed addresses place 250.

Upon completion of the simulation, there should be no tokens remaining in the malloc place 220 or the free place 230 if memory usage was performed correctly by the target system. If used correctly, each malloc call should have a corresponding free call. When tokens remain in the malloc place 220, it means that their corresponding allocated memory address was not properly freed. When tokens remain in the free place 230, it means that their corresponding freed memory address was not previously allocated or a double free occurred on the same address.

Thus, in one embodiment, after the runtime data is simulated through the CP-net model: (i) a memory usage error is generated representing that the heap memory has been incorrectly used if any tokens are present in either the malloc place 220 and/or the free place 230; and (ii) a verification message may generated representing that the heap memory has been correctly used if no tokens are present in both the malloc place 220 and the free place 230. These conditions may be easily determined by a user simply by reviewing the visual graphical state of the CP-net model 200.

Furthermore, the model 200 may be configured with selectable graphical components. Upon selecting any of the defined “places,” the system may display a pop-up window showing a list of tokens and the properties/attributes of each token contained in the selected place. The list may provide for each token, a token number and the token attributes, for example, [file: ‘run. c’, line: 50, time: 1, addr: 5253] associated with the place. This allows a user to see the specific properties/attributes of the function calls that are associated with each token including the source file that made the call, line of code, memory address involved, time, etc. More details are provided below.

### Second Embodiment for a Technique for Verification of Safety Properties

In another embodiment, the present security system may be configured with a technique to verify memory safety and check the memory usage properties defined above. The technique may encompass steps, including but not limited to, defining a data model for runtime data, collecting and/or retrieving runtime data, constructing Colored Petri nets (CP-nets), simulating the CP-nets using runtime data, and detecting memory safety violations. These steps are elaborated below. It is noted that the present system is not coupled or limited to any specific CP-net formal modeling tool or syntax. For simplicity of explanation, we use the ExSpect tool and its syntax to explain, but any syntax may be used. The present technique is not limited to the order or sequence of the following steps/actions since different sequences may be implemented.

### Step 1: Defining a Runtime Data Model

The system under test (target system) may be configured to emit logs of relevant runtime events such as a) where is the malloc function called from, b) what is the returned pointer value of a malloc call, c) where is the free function called from, d) what is the data parameter passed as the input to the free function, and so forth. Thus, we formalize a data model for further analysis. To model the above events in a colored petri net model (CP-net model), two abstract data types may be defined as are formalized below.

The action type is made of attributes including but not limited to: filename (source of action), line number, time the action happened, and the memory address/pointer involved. One example syntax and data structure for storing the attributes may be [file: str, line: num, time: num, addr: num] where str and num denote string and integer types, respectively. In one embodiment, this type data that stores the attributes of an action may be assigned to a corresponding token in the CP-net model. The token represents an instance of the action and stores the associated attributes.

For example, a malloc action/event can be modeled as [file: ‘run. c’, line: 50, time: 1, addr: 5253] which is interpreted as a runtime call was made to the malloc( ) function that was started at line 50 in file “run.c” at time t=1, and 5253 is the address returned by the malloc( ) function. The CP-net model is configured to generate a token representing this malloc event and the token contains the attributes of the event as [file: ‘run.c’, line: 50, time: 1, addr: 5253].

The second data type is address_time which may be formally defined as [addr: num, time: num]. We will later give an example of how we use this data type in this technique.

In the CP-net model, when a user selects/clicks on a Place of an action (e.g., malloc, free, use), a pop-up window may be displayed showing a list of the tokens/members of the associated action along with each token's attributes/properties. The list may provide for each token, a token number and the token attributes, for example, [file: ‘run.c’, line: 50, time: 1, addr: 5253] associated with the action.

### Step 2: Collecting Runtime Data

The present technique is not coupled or limited to a particular instrumentation technique or specific data collection method. For example, runtime instrumentation may be used to modify the binary code to generate the above data, or load-time techniques are used to collect the same data. The present technique assumes that the logs of relevant runtime data, containing data used by the present data model defined in Step 1, can be collected in any manner from a running system to perform memory safety analysis.

### Step 3: Constructing Colored Petri Nets (CP-Nets)

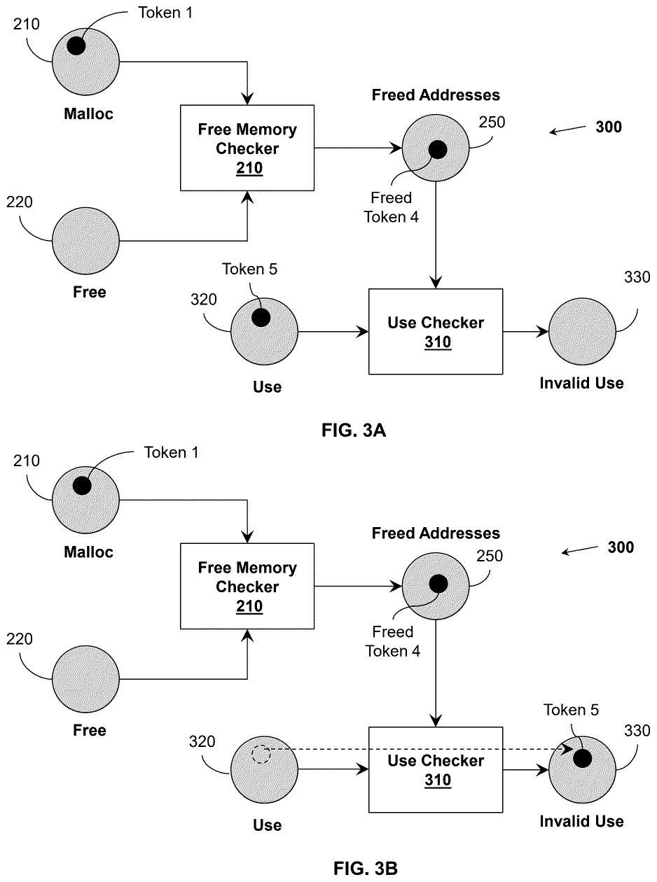

One embodiment of a CP-net model 300 that verifies whether heap memory APls are used correctly is shown with reference to FIG. 3A, which is an expanded version of model 200 in FIG. 2A. Similar components are labeled with the same reference numbers. CP-net Model 300 includes an additional transition called use checker 310 configured to check and detect whether freed memory is invalidly used in the target system. Example syntax and semantics may be as follows.

In other embodiments, the model 300 may be easily modified and/or expanded to detect other types of heap memory usage and/or misusage actions by adding new transitions with defined preconditions that cause the transition to fire. The transitions may then be connected to the CP-net model 300 and connected to appropriate input places. For example, a NULL checker transition may be defined to check for a malloc call that returns a NULL pointer. This occurs when there is insufficient memory in the system to satisfy the requested size of memory in the malloc call. This condition may be regarded as a memory use violation. Receiving a NULL pointer may cause problems downstream in the code.

### Verification of Safety Property 1 and Property 2

With reference to FIG. 3A, the CP-net model 300 may be configured to detect and ensure various properties associated with memory usage. As stated previously, Property 1 is the “Free after malloc” property and Property 2 is the “Free is called once” property, which detects a “Double free” violation.

The Free Memory Checker transition 210 has two input places Malloc 210 and Free 220 similar to FIG. 2A. This transition 210 is configured to check whether the allocated memory addresses are properly freed. The properly freed memory addresses are then stored in the output place (Freed Address 230) as tokens and are displayed as graphical tokens in the graphical user interface.

The Free Memory Checker transition 210 is defined with a precondition rule to achieve this task, for example:
Precondition: Malloc@addr=Free@addr and Malloc@time<Free@time

Here, the free memory checker 210 reviews the current token addresses from the Malloc place 210 (Malloc@addr) and compares them to the current token addresses from the Free place 220 (Free@addr). This may be performed sequentially and/or concurrently, and may be a continuous review process.

The precondition looks for an allocated token address that matches a freed token address and then determines whether the time of allocation occurred before the time of the free call (Malloc@time<Free@time). lf this precondition is satisfied, the token from the Malloc place 210 and the corresponding token from the Free place 220 are removed. The output place Freed Addresses 230, which is of the datatype address_time defined in the previous step, is populated to have a token that contains attributes including the address that was freed and the time of its free( ) call. This may be formally defined as follows:
Freed_Address<-[addr:Malloc@addr, time:Free@time]

The same transition Free Memory Checker 210 can also be used to detect double free memory use because there will be two tokens in the Free place 220 for the same address but with only one matching malloc token inside the Malloc place 210. This is further discussed in Step 5.

### Verification of Safety Property 3

As stated above, Property 3 refers to the invalid use condition “There is no use after free” which means once a memory address is freed, that memory address cannot and should not be used.

Examples of invalid use include the following. (a) Dereferencing the freed pointer which is caused by accessing or modifying data at a freed memory address. This can result in segmentation faults or unpredictable behavior; (b) Double Free attempts to free the same memory address multiple times. This can lead to memory corruption and security vulnerabilities (e.g., double-free exploits); (c) Reading from the freed address where the data at a freed memory location is no longer valid and may be overwritten by other allocations, leading to incorrect results or system crashes; (d) Writing to deallocated memory can corrupt other active memory segments, causing unpredictable program behavior. Thus, the code should not write data to a freed address; (e) Performing pointer arithmetic on a freed pointer is invalid because it no longer points to a valid memory block; (f) Relying on memory content after freeing should be avoid because the contents of a freed memory block may be altered or repurposed by the system or other processes, making any reliance on previous data unsafe. One or more of these types of invalid use conditions may be defined and implemented in the CP-net model.

With continued reference to FIG. 3, in one embodiment, a Use Checker transition 310 may be implemented in the CP-net model 300 that is configured to check whether any freed memory is used after it was freed. The Use Checker transition 310 may have two input places including the Freed Addresses place 250 and a Use place 320. The Freed Addresses place 250 contains all tokens that represent correctly freed memory addresses as previously described. The Use place 320 contains tokens that represent memory addresses that are used during runtime.

Similar to the other “places” in the CP-net model 300, each time a memory address is used in the target system (e.g., an instance of a memory usage function such as read or write function), a use token is generated for that use. The use token is then populated into the use place 320. In FIG. 3A, token 5 represents that a memory address was used during runtime. Token 5 may be configured to contain various attributes associated with the memory use, for example but not limited to, the file/application source of the use, line number of the use function call, the memory address or pointer, type of use, and time of use.

An output place called Invalid use 330 may be configured to contain tokens that represent memory addresses that are invalidly used or referenced after the memory addresses are freed. This determination may be defined as a precondition in the transition of the Use Checker 310 as:
Freed_Addr@addr=Use@addr and Freed_Addr@time<Use@time

For example, the use checker 310 processes input tokens and analyzes their attributes. Freed_Addr@addr represents an address (addr) from a token in the freed addresses place 250 and Freed_Addr@time represents the time the address was freed, as contained in the token. Use@addr represents an address (addr) from a use token in the use place 320 and Use@time represents the time the address was used, as contained in the use token.

The precondition of the transition is checking whether there are references to freed memory addresses (as identified by the tokens in the freed addresses place 250) using the time of free and the time of use. In other words, if a freed address token (e.g., Token 4) matches a used address token (e.g., Token 5) and the time of use occurs after the time the memory address is freed, then that is a detected invalid use.

If the above precondition is satisfied, those invalid memory references are detected and their corresponding tokens are moved out of the use place 320 and stored in the output place Invalid use 330:
Invalid_use<-Use

For example, if the use memory address of Token 5 matches any freed memory address in the Freed Addresses place 250 and the time condition is satisfied, then Token 5 is moved to the invalid use place 330, as seen in FIG. 3B. This provides a visual indication that an invalid memory use has occurred in the target system under test. Clicking on the invalid use place 330 (in the graphical user interface) may then generate a pop-up window that displays all invalid use tokens contained in the invalid use place along with the attributes of each token. This allows for quick identification and location of where the invalid use occurred in the runtime code. This technique reduces or even eliminates manual debugging and analysis of code regardless of the size of the target system under test (e.g., which may be thousands, or millions of lines of code).

### Step 4: Simulating the CP-Nets

The CP-net model 300 shown in FIG. 3A may be executed with actual runtime data to detect memory safety violations. To do so, the input places such as Malloc 210, Free 220, and Use 320 are populated with tokens representing actual data that conforms to the data model defined in Step 1. Once the input places are filled, simulation of CP-nets is started, however the order may be reversed. The simulation causes the CP-net model 300 to analyze token properties and move tokens around the CP-net whenever preconditions defined in Step 3 are satisfied.

### Step 5: Inspecting the State of CP-Nets for Safety Violations

After the simulation is performed, the resulting state of the Petri net may be inspected to check memory safety properties and detect safety violations. The resulting state is easily reviewed simply by seeing where tokens exist. FIG. 3B shows an example resulting state.

### Property 1: Allocated Memory Addresses are Freed

The Freed Address place 250 will contain tokens that represent memory addresses that are correctly freed.

### Property 2: Detecting Missing Free( )

If any memory addresses obtained from malloc place 210 are not freed, the CP-net 300 will have tokens remaining in the input place Malloc 210 because the precondition for firing the transition would not be satisfied. Thus, any remaining tokens in malloc 210 represent allocated memory addresses that were not properly freed/deallocated (e.g., Token 1 in FIG. 3B). If all allocated memory addresses are properly freed during runtime in the target system under test, then the malloc place 210 will not contain any tokens and the free place 220 will not contain any tokens.

If any memory addresses are freed more than once (e.g., a double free error), then the resulting state of the model will contain a corresponding token in the free place 220. Thus, when the target system under test correctly allocates and deallocates memory, the resulting state will have no tokens in the malloc place 210 and no tokens in the free place 220, which is easily visually observed in the CP-net model 300. This also means that a double free violation did not occur.

### Property 3: Detecting Use After Free( )

When any memory addresses are used after they are freed, the Invalid use place 330 will contain tokens corresponding to those addresses. Thus, when the target system under test does not contain any memory errors for which the CP-net model 300 is configured to detect, tokens should only be seen in the freed addresses place 250 and the use place 320.

Accordingly, the present technique and implementation of a colored petri net model provides for an improved technique for the detection and prevention of security vulnerabilities due to misuse of heap memory. The present colored petri net model, configured to detect memory misusage, is particularly useful for modeling memory usage in concurrent, distributed, and/or asynchronous systems, allowing for the visualization and analysis of complex interactions and dependencies of memory usage. The present system may also be used for memory usage verification, simulation, and performance analysis based on the types of memory usage conditions that are defined and modeled by transitions and places implemented in the model as described herein.

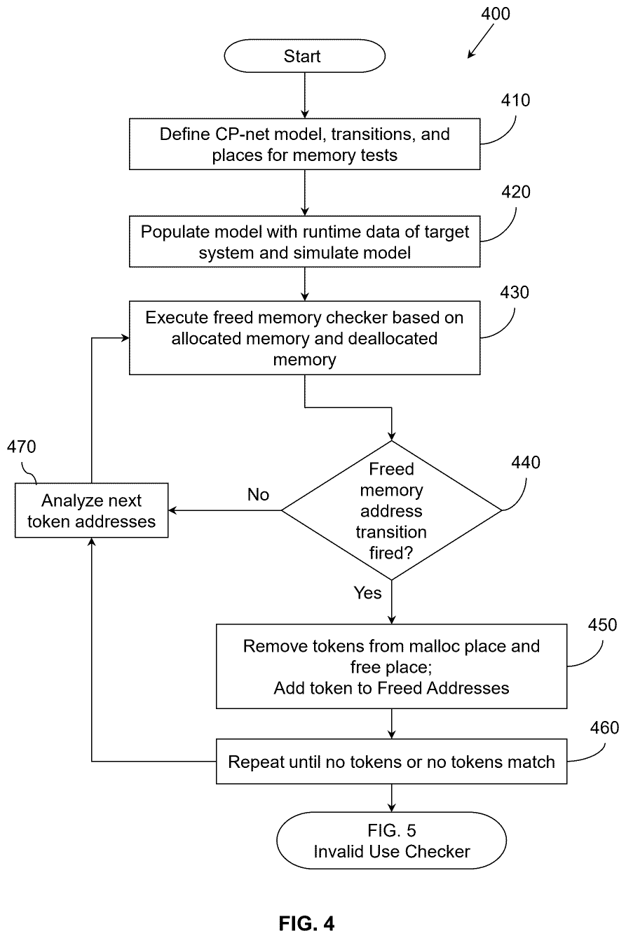

FIG. 4 illustrates one embodiment of a method 400 associated with the detection and prevention of security vulnerabilities due to misuse of heap memory. In this example, method 400 will be described based on the CP-net model 300 shown in FIG. 3A including the free memory checker transition 210 and the use checker transition 310. In another embodiment, the method 400 may be based on the model 200 shown in FIG. 2A including the free memory checker transition 210. Details of the various functions performed are similar to those previously described and are applicable to method 400.

At block 410, a runtime data model is defined and implemented as a colored petri net model (CP-net model) as previously described including the free memory checker transition 210 and the use checker transition 310. In other embodiments, different types of transitions may be implemented based on what type of memory usage functions are desired to be model and analyzed.

At block 420, the CP-net model is populated with runtime data that has been collected from a target system under test. Tokens are generated for each memory allocation function (malloc), each memory deallocation function (free), and each memory usage function (read/write) that occurred during runtime. The tokens are stored in their corresponding places in the model as previously described.

The CP-net model is then executed and simulated to initiate the movement of tokens between places as transitions are fired based on the predefined conditions/rules of each transition as previously described. When a transition “fires,” it consumes tokens from its input places and produces tokens in its output places, based on the predefined conditions/rules.

At block 430, the freed memory checker transition compares and analyzes the tokens (and their attributes) associated with allocated memory and deallocated memory that are contained in the malloc place and free place, respectively. For example, based on a precondition: Malloc@addr=Free@addr and Malloc@time<Free@time, the free memory checker reviews the current token addresses from the Malloc place (Malloc@addr) and compares them to the current token addresses from the Free place (Free@addr) looking for matching addresses.

At block 440, the method determines if the free memory checker transition fires for any allocated and deallocated tokens. When malloc and free addresses match, the transition will fire only when the time of the deallocation (free call) is after the time of the allocation (malloc call).

At block 450, when the freed memory checker precondition is satisfied, the corresponding tokens are removed from the malloc place and the free place, and a freed address token is added to the output place freed addresses.

At block 460, the process for the freed memory checker repeats with the next token addresses at block 470 until there are no more allocated memory tokens (no tokens in the malloc place), there are no more deallocated memory tokens (no tokens in the free place), and/or there are more tokens but no more matching token addresses.

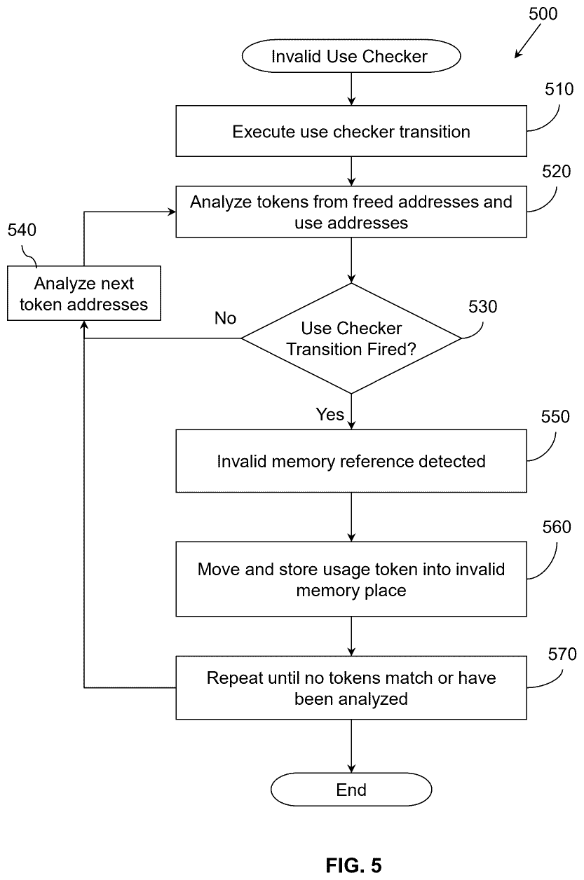

Method 400 continues in FIG. 5 which is associated with the use checker transition 310 of the CP-net model 300 (from FIG. 3). It is noted that the transitions of method 400 may be executed sequentially and/or concurrently. For example, the freed memory checker transition and the use checker transition may each be initiated and executed in the model based on the presence of tokens within their input places. Thus, the existence of one or more tokens in their input places trigger the transition to determine whether their defined preconditions are fired or not.

With reference to FIG. 5, at block 510, the use checker is executed by the model. At block 520, the use checker transition analyzes tokens from the freed address place and the use address place (the input places).

At block 530, the method determines when the use checker transition is fired for particular instances of memory usage. In one embodiment, the use checker transition may include the precondition Freed_Addr@addr=Use@addr and Freed_Addr@time<Use@time as described previously. This precondition is checking whether there are any use token addresses that match a freed address token.

When a freed address and use address match, this means there was a usage reference to a freed memory address. However, the precondition also checks the time when the memory was freed (time of free call) and the time of the usage of that memory. When the usage time of a memory address occurs after the memory address is freed, that is an invalid usage and the transition is fired. When the usage time of a memory address occurs before the memory address is freed, that is a valid usage and the transition is not fired. The next token addresses are analyzed at block 540 and the process repeats.

The method moves to block 550 when the precondition of the use checker transition is satisfied for a particular use token, which is a detected invalid memory reference.

At block 560, the particular use token (and its memory attributes) that caused the transition to fire is removed from the use input place and then moved into the output place representing invalid memory usages.

At block 570, the process for the memory use checker repeats with the next token addresses at block 540 until there are no more usage tokens (no tokens in the use place) that match any of the freed address tokens in the freed address place and/or when all tokens have been analyzed.

As previously described, the present memory security system provides a runtime model-based technique for detecting and preventing memory usage violations in a target software system. The present system further provides a visual representation in graphical form of memory usage for the target system that allows for simple investigation and analysis of the target system. The graphical end state of the runtime model (CP-net model) after simulation visually identifies whether any memory misusage has occurred based on the final locations of tokens. Thus, the present technique detects and prevents incorrect usage of heap memory in a target system (e.g., system under test) in an improved manner.

### Cloud or Enterprise Embodiments

In one embodiment, the memory security system 100 (FIG. 1) is a computing/data processing system including an application or collection of distributed applications for enterprise organizations that implement the present system and methods. The applications and computing system may be configured to operate with or be implemented as a cloud-based networking system, a software as a service (SaaS) architecture, or other type of networked computing solution including one or more computing devices operably connected to communicate over one or more communication networks via one or more network interfaces that form a computing system. In one embodiment, the memory security system 100 is a centralized server-side application that provides at least the functions disclosed herein and that is accessed by remote users via computing devices/terminals communicating with the computing system 100 (functioning as the server) over a computer network.

In one embodiment, one or more of the components described herein are configured as program modules stored in a non-transitory computer readable medium as part of a computing system. The program modules are configured with stored instructions that when executed by at least a processor cause the computing device to perform the corresponding function(s) as described herein.

### Computing Device Embodiment

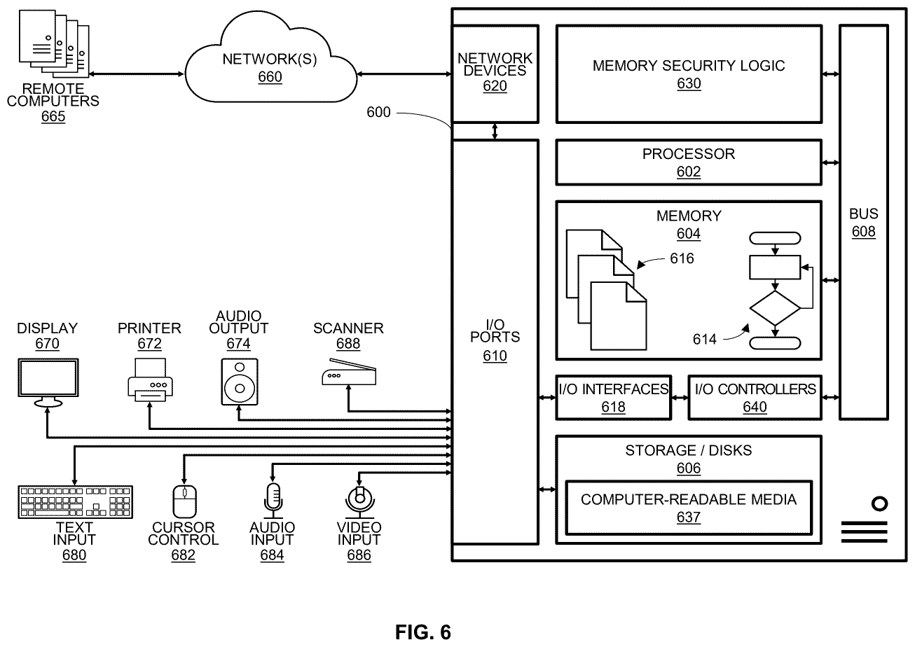

FIG. 6 illustrates an example computing device that is configured and/or programmed as a special purpose computing device with one or more of the example systems and methods described herein, and/or equivalents. The example computing device may be a computer 600 that includes at least one hardware processor 602, a memory 604, and input/output ports 610 operably connected by a bus 608. In one example, the computer 600 may include memory security logic 630 configured to facilitate detecting memory security/safety vulnerabilities similar to memory security system 100 shown in any FIGS. 1-5.

In different examples, the logic 630 may be implemented in hardware, a non-transitory computer-readable medium 637 with stored instructions, firmware, and/or combinations thereof. While the logic 630 is illustrated as a hardware component attached to the bus 608, it is to be appreciated that in other embodiments, the logic 630 could be implemented in the processor 602, stored in memory 604, or stored in disk 606.

In one embodiment, logic 630 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to detect memory security/safety vulnerabilities. The means may also be implemented as stored computer executable instructions that are presented to computer 600 as data 616 that are temporarily stored in memory 604 and then executed by processor 602.

Logic 630 may also provide means (e.g., hardware, non-transitory computer-readable medium that stores executable instructions, firmware) for performing one or more of the disclosed functions and/or combinations of the functions.

Generally describing an example configuration of the computer 600, the processor 602 may be a variety of various processors including dual microprocessor and other multi-processor architectures. A memory 604 may include volatile memory and/or non-volatile memory. Non-volatile memory may include, for example, ROM, PROM, and so on. Volatile memory may include, for example, RAM, SRAM, DRAM, and so on.

A storage disk 606 may be operably connected to the computer 600 via, for example, an input/output (I/O) interface (e.g., card, device) 618 and an input/output port 610 that are controlled by at least an input/output (I/O) controller 640. The disk 606 may be, for example, a magnetic disk drive, a solid state disk drive, a floppy disk drive, a tape drive, a Zip drive, a flash memory card, a memory stick, and so on. Furthermore, the disk 606 may be a CD-ROM drive, a CD-R drive, a CD-RW drive, a DVD ROM, and so on. The memory 604 can store a process 614 and/or a data 616, for example. The disk 606 and/or the memory 604 can store an operating system that controls and allocates resources of the computer 600.

The computer 600 may interact with, control, and/or be controlled by input/output (I/O) devices via the input/output (I/O) controller 640, the I/O interfaces 618, and the input/output ports 610. Input/output devices may include, for example, one or more displays 670, printers 672 (such as inkjet, laser, or 3D printers), audio output devices 674 (such as speakers or headphones), text input devices 680 (such as keyboards), cursor control devices 682 for pointing and selection inputs (such as mice, trackballs, touch screens, joysticks, pointing sticks, electronic styluses, electronic pen tablets), audio input devices 684 (such as microphones or external audio players), video input devices 686 (such as video and still cameras, or external video players), image scanners 688, video cards (not shown), disks 606, network devices 620, and so on. The input/output ports 610 may include, for example, serial ports, parallel ports, and USB ports.

The computer 600 can operate in a network environment and thus may be connected to the network devices 620 via the I/O interfaces 618, and/or the I/O ports 610. Through the network devices 620, the computer 600 may interact with a network 660. Through the network, the computer 600 may be logically connected to remote computers 665. Networks with which the computer 600 may interact include, but are not limited to, a LAN, a WAN, and other networks.

### Definitions and Other Embodiments

In another embodiment, the described systems, methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

An “operable connection”, or a connection by which entities are “operably connected”, is one in which one or more communication channels are established (or may be established upon request) that allow signals, data, messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When intended to indicate “only A or B but not both” then the phrase “only A or B but not both” will be used. Thus, use of the term “or” herein is the inclusive, and not the exclusive use.

What is claimed is:

1. A non-transitory computer-readable medium that includes stored thereon computer-executable instructions that when executed by at least a processor of a computing system, wherein the computing system includes one or more computing devices, cause the computing system to:
define a runtime data model based on a petri net configured to track heap memory usage in a target system, wherein the runtime data model tracks heap memory allocation functions and heap memory deallocation functions;
execute the target system and collect runtime data including the heap memory usage;
simulate the runtime data model in the petri net with the runtime data, wherein the runtime data model associates the heap memory allocation functions with corresponding heap memory deallocation functions in a visual graphical format;
detecting security vulnerabilities where a specific heap memory allocation function does not have a corresponding heap memory deallocation function; and
generating an alert that identifies the security vulnerabilities including the associated specific heap memory allocation function that does not have the corresponding heap memory deallocation function.

2. The non-transitory computer-readable medium of claim 1, wherein the runtime data model is configured as a colored petri net model;
wherein the colored petri net model defines a visual model including a free memory checker as a transition that includes:
a first input place that tracks the heap memory allocation functions with first tokens, wherein each first token corresponds to a specific instance of a memory allocation and contains an allocated memory address;
a second input place that tracks the heap memory deallocation functions with second tokens, wherein each second token corresponds to a specific instance of a memory deallocation and a freed memory address that was deallocated; and
a freed address output place that tracks tokens for freed memory addresses that are correctly allocated and deallocated in the runtime data based on a precondition rule.

3. The non-transitory computer-readable medium of claim 2,
wherein the transition of the free memory checker defines the precondition rule that when an allocated memory address of a first token from the first input place corresponds to a freed memory address of a second token in the second input place, then:
(i) the first token is removed from the first input place that tracks the heap memory allocation functions;
(ii) the second token is removed from the second input place that tracks the heap memory deallocation functions; and
(iii) the freed address output place is populated with a freed token that contains the freed memory address and a time of deallocation.

4. The non-transitory computer-readable medium of claim 2, further comprising instructions that when executed by at least the processor cause the processor to:
wherein after the runtime data is simulated through the colored petri net model:
(i) a memory usage error is generated representing that the heap memory has been incorrectly used if any tokens are present in either the first input place and the second input place; and
(ii) a verification message is generated representing that the heap memory has been correctly used if no tokens are present in both the first input place and the second input place.

5. The non-transitory computer-readable medium of claim 2, wherein the colored petri net model further comprising:
a use checker transition configured to receive input tokens from the freed address place and from a use place;
wherein colored petri net model is configured to generate a use token for each instance of a memory usage function and populate the use place with the use token, wherein the use token represents a memory address that is used by the memory usage function during runtime; and
wherein the use checker is configured to detect when freed memory from the freed address place is invalidly used after being freed based on the use tokens in the use place.

6. The non-transitory computer-readable medium of claim 1,
wherein the runtime data model is configured as a colored petri net that includes:
a malloc place defined in a first graphical component of the visual graphical format, wherein the malloc place is populated with tokens for each malloc function that occurs in the runtime data; and
a free place defined in a second graphical component of the visual graphical format, wherein the free place is populated with tokens for each free function that occurs in the runtime data; and
wherein the runtime data model is configured with a transition configured to remove a token from the malloc place and remove a corresponding token from the free place when a particular memory address is correctly allocated and deallocated as represented by the tokens.

7. The non-transitory computer-readable medium of claim 1, further comprising instructions that when executed by at least the processor cause the processor to:
generate the alert that identifies the security vulnerabilities as part of a graphical end state of the runtime data model upon completion of the simulation of the runtime data in the petri net.

8. A computing system, comprising:
one or more computing devices operably connected to communicate over one or more communication networks via one or more network interfaces;
at least one processor connected to at least one memory, wherein the at least one processor is operably connected to at least one of the one or more computing devices; and
a non-transitory computer readable medium including instructions stored thereon that when executed by at least the processor cause the computing system to:
access and retrieve runtime data collected from a target software system;
populate a runtime data model, implemented as a colored petri net model, with data from the runtime data, wherein the colored petri net model is configured to identify and track heap memory usage in the target system and detect memory security violations, wherein the colored petri net model tracks at least heap memory allocation functions and heap memory deallocation functions based on the runtime data;
simulate the colored petri net model with the runtime data to detect memory security violations;
wherein the colored petri net model is configured to populate a memory allocation place with an allocation token for each heap memory allocation function that occurs in the runtime data;
wherein the colored petri net model is configured to populate a memory deallocation place with a deallocation token for each heap memory deallocation function that occurs in the runtime data;
wherein the colored petri net model is further configured to associate the allocation tokens with corresponding deallocation tokens in a visual graphical format;
detecting security vulnerabilities where an allocation token for a specific heap memory allocation function does not have a corresponding deallocation token for a corresponding heap memory deallocation function; and
generating an end state of the colored petri net model in the visual graphical format, wherein upon completion of the simulation, the end state identifies the security vulnerabilities including the associated specific heap memory allocation function based on locations of the allocation tokens and locations of the deallocation tokens in the colored petri net model.

9. The computing system of claim 8, wherein the colored petri net model includes a free memory checker configured as a transition that includes:
the memory allocation place as a first input to the transition that tracks the heap memory allocation functions with the allocation tokens, wherein each allocation token corresponds to a specific instance of a memory allocation and contains an allocated memory address;
the memory deallocation place as a second input to the transition that tracks the heap memory deallocation functions with the deallocation tokens, wherein each deallocation token corresponds to a specific instance of a memory deallocation and a freed memory address that was deallocated; and
a freed address output place that tracks tokens for freed memory addresses that are correctly allocated and deallocated in the runtime data based on a precondition rule.

10. The computing system of claim 9,
wherein the transition of the free memory checker further defines the precondition rule that when an allocated memory address of a first token from the memory allocation place corresponds to a freed memory address of a second token in the memory deallocation place, then:
(i) the first token is removed from the memory allocation place that tracks the heap memory allocation functions;
(ii) the second token is removed from the memory deallocation place that tracks the heap memory deallocation functions; and
(iii) the freed address output place is populated with a freed token that contains the freed memory address and a time of deallocation.

11. The computing system of claim 9,
wherein after the runtime data is simulated through the colored petri net model:
(i) a memory usage error is generated representing that the heap memory has been incorrectly used if any tokens are present in either the memory allocation place and the memory deallocation place; and
(ii) a verification message is generated representing that the heap memory has been correctly used if no tokens are present in both the memory allocation place and the memory deallocation place.

12. The computing system of claim 9, wherein the colored petri net model further comprising:
a use checker transition configured to receive input tokens from the freed address place and from a use place;
wherein colored petri net model is configured to generate a use token for each instance of a memory usage function and populate the use place with the use token, wherein the use token represents a memory address that is used by the memory usage function during runtime; and
wherein the use checker is configured to detect when freed memory from the freed address place is invalidly used after being freed based on the use tokens in the use place.

13. The computing system of claim 8, wherein:
the memory allocation place is defined in a first graphical component in the colored petri net model, wherein the memory allocation place is populated with an allocation token for each malloc function that occurs in the runtime data; and
the memory deallocation place is defined in a second graphical component in the colored petri net model, wherein the memory deallocation place is populated with a deallocation token for each free function that occurs in the runtime data; and
wherein the colored petri net model is configured with a transition configured to remove an allocation token from the memory allocation place and remove a corresponding deallocation token from the memory deallocation place when a particular memory address is correctly allocated and deallocated as represented by the allocation token and the corresponding deallocation token.

14. A computer-implemented method, the method comprising:
defining a runtime data model, implemented as a colored petri net model, wherein the colored petri net model is configured to identify and track heap memory usage in a target software system and detect memory security violations, wherein the colored petri net model tracks at least heap memory allocation functions and heap memory deallocation functions based on a runtime data;
accessing and retrieving, from a database, the runtime data collected from the target software system;
populating the colored petri net model, with data from the runtime data, wherein the colored petri net model tracks at least heap memory allocation functions and heap memory deallocation functions based on the runtime data;
simulating the colored petri net model with the runtime data to detect memory security violations;
populating a memory allocation place, in the colored petri net model, with an allocation token for each heap memory allocation function that occurs in the runtime data;
populating a memory deallocation place, in the colored petri net model, with a deallocation token for each heap memory deallocation function that occurs in the runtime data;
associating, by the colored petri net model, the allocation tokens with corresponding deallocation tokens based on memory addresses;
detecting security vulnerabilities where an allocation token for a specific heap memory allocation function does not have a corresponding deallocation token for a corresponding heap memory deallocation function; and
generating an end state of the colored petri net model in a visual graphical format, wherein upon completion of the simulation, the end state identifies the security vulnerabilities including the associated specific heap memory allocation function based on locations of the allocation tokens and locations of the deallocation tokens in the colored petri net model.

15. The method of claim 14, further comprising:
defining the colored petri net model to include a free memory checker configured as a transition that includes:
the memory allocation place as a first input to the transition that tracks the heap memory allocation functions with the allocation tokens, wherein each allocation token corresponds to a specific instance of a memory allocation and contains an allocated memory address;
the memory deallocation place as a second input to the transition that tracks the heap memory deallocation functions with the deallocation tokens, wherein each allocation token corresponds to a specific instance of a memory deallocation and a freed memory address that was deallocated; and
a freed address output place that tracks tokens for freed memory addresses that are correctly allocated and deallocated in the runtime data based on a precondition rule.

16. The method of claim 15, further comprising
configuring the transition of the free memory checker with the precondition rule that when an allocated memory address of a first allocation token from the memory allocation place corresponds to a freed memory address of a second deallocation token in the memory deallocation place, then:
(i) removing the first allocation token from the memory allocation place that tracks the heap memory allocation functions;
(ii) removing the second deallocation token from the memory deallocation place that tracks the heap memory deallocation functions; and
(iii) populating the freed address output place with a freed token that contains the freed memory address and a time of deallocation.

17. The method of claim 15,
wherein after the runtime data is simulated through the colored petri net model:
(i) generating a memory usage error representing that the heap memory has been incorrectly used if any tokens are present in either the memory allocation place and the memory deallocation place; and
(ii) generating a verification message representing that the heap memory has been correctly used if no tokens are present in both the memory allocation place and the memory deallocation place.

18. The method of claim 15, further comprising:
defining the colored petri net model to include a use checker transition configured to receive input tokens from the freed address place and from a use place;
generating, by colored petri net model, a use token for each instance of a memory usage function in the runtime data
populating the use place with the use token, wherein the use token represents a memory address that is used by the memory usage function during runtime; and
detecting, by the use checker transition, when freed memory from the freed address place is invalidly used after being freed based on the use tokens in the use place.

19. The method of claim 15, wherein:
configuring the memory allocation place in a first graphical component in the colored petri net model, wherein the memory allocation place is populated with an allocation token for each malloc function that occurs in the runtime data; and
configuring the memory deallocation place in a second graphical component in the colored petri net model, wherein the memory deallocation place is populated with a deallocation token for each free function that occurs in the runtime data; and
configuring the colored petri net model with a transition that removes an allocation token from the memory allocation place and removes a corresponding deallocation token from the memory deallocation place when a particular memory address is correctly allocated and deallocated as represented by the allocation token and the corresponding deallocation token.

20. The method of claim 15, further comprising:
generating and transmitting an alert that identifies the security vulnerabilities including the associated specific heap memory allocation function that does not have the corresponding heap memory deallocation function.
